(19) United States
(12) Patent Application Publication
(10) Pub. No.: US 2003/0180576 A1
(43) Pub. Date: Sep. 25, 2003

(54) Magnetic recording medium

(75) Inventors: Miyabi Nakamura, Ibaragi (JP); Takahiro Shimizu, Nagano (JP); Hiroyuki Uwazumi, Nagano (JP); Naoki Takizawa, Nagano (JP); Tadaaki Oikawa, Nagano (JP)

Correspondence Address: ROSSI & ASSOCIATES, P.O. Box 826, Ashburn, VA, 20146-0826, US

(73) Assignee: Fuji Electric Co., Ltd.

(21) Appl. No.: 10/337,956

(22) Filed: Jan. 7, 2003

(30) Foreign Application Priority Data
Jan. 7, 2002 (JP) 2002-000926

(51) Int. Cl. G11B 5/66

(52) U.S. Cl. 428/694 MM; 428/694 BH; 428/694 R

(57) ABSTRACT

A magnetic recording medium is provided that exhibits excellent magnetic and electromagnetic conversion characteristics and allows stable high density recording with little effect of thermal disturbances. Specifically, a magnetic recording medium uses a substrate of plastic resin, such as polycarbonate or polyolefin, not subjected to intentional heating. A magnetic layer has a granular structure consisting of ferromagnetic crystalline grains with hexagonal closest packed structure and nonmagnetic grain boundary region of mainly oxide intervening between the ferromagnetic crystalline grains. An underlayer has a body centered cubic structure. A nonmagnetic intermediate layer with a hexagonal closest packed structure is provided between the magnetic layer 4 and the underlayer. The intermediate layer is composed of a nonmagnetic metallic substance of substantially one or more elements selected from Ru, Os, and Re.

### TECHNICAL FIELD OF THE INVENTION

The present invention relates in general to a magnetic recording medium and, in particular, to a magnetic recording medium that exhibits excellent magnetic properties and electromagnetic conversion characteristics, stability against thermal disturbances, and allows high recording density.

### BACKGROUND OF THE INVENTION

A magnetic storage device is one type of information recording device used to support our highly informational society in recent years. With increases of information to vast amounts, magnetic recording media used in magnetic storage devices are forced towards higher recording density and lower noise. Achieving high recording density needs minimization of a unit size of inversion of magnetization, which in turn requires minute magnetic grain size. Lowering of noises needs reduction of fluctuation of magnetization due to magnetic interaction between grains, in addition to the minute grain size.

To address these problems, a variety of proposals have been made including compositions and structures of a magnetic layer, and materials for a nonmagnetic underlayer and a seed layer. Among them, a type of medium has been proposed having a so-called granular magnetic layer consisting of magnetic crystalline grains and nonmagnetic matrix of an oxide or a nitride surrounding the crystal grains. In a medium including a granular structure, the magnetic grains are nearly perfectly isolated magnetically from each other by virtue of the intervening nonmagnetic substance. Since the minimum magnetization unit can be the size of individual grain, which is 4 to 10 nm, high recording density is possible to at least this minute dimension. Besides, exchange interaction between the grains is expected to be suppressed by the nonmagnetic matrix surrounding each grain.

U.S. Pat. No. 5,679,473, for example, discloses that low noise is achieved by a granular recording film having a structure in which each magnetic crystalline grain is separated by nonmagnetic oxide surrounding the grain. The granular recording film in the reference can be formed by deposition employing RF sputtering using a target of CoNiPt with an additive of an oxide such as SiO₂. In such a granular magnetic film, since a nonmagnetic and nonmetallic phase physically separates each magnetic grain, magnetic interaction between the magnetic grains diminishes. So the formation of zigzag magnetic domain wall is suppressed that arises at a transition region of a recording bit, leading to achieving low noise characteristic.

In order to accomplish a magnetic recording medium with excellent electromagnetic conversion characteristic using a granular magnetic layer, oxide such as SiO₂ and the cobalt alloy that are contained in the target need to be well separated in the deposited magnetic layer. It is also important to make the size of the magnetic grain small to reduce noises.

If a degree of mismatching between a c-axis lattice constant of the magnetic layer and a c-axis lattice constant of the intermediate layer is not less than 5%, however, the mismatching between the layers inhibits epitaxial growth of the magnetic layer deposited on the intermediate layer and adversely affects alignment and crystallinity of the crystalline grains constituting the magnetic layer, and further, inhibits segregation of the oxide from the cobalt alloy particles.

Because these phenomena lead to degradation of electromagnetic conversion characteristics, control of the lattice matching is required between the intermediate layer and the magnetic layer to reduce media noise.

In view of the above, it would be desirable to provide a magnetic recording medium that exhibits excellent magnetic properties and electromagnetic conversion characteristics, and stability against thermal disturbances, allowing achieving high recording density.

### SUMMARY OF THE INVENTION

The inventors of the present invention have made extensive studies on lattice matching between crystalline grains of the nonmagnetic intermediate layer and in the magnetic layer in a magnetic recording media having a granular magnetic layer, and found the following facts. The conditions of lattice constants are favorable when the degree of mismatching Δa is not greater than 6%, the degree of mismatching Δc is not greater than 4%, and the ratio Δa/Δc is not smaller than 1.5; where Δa is the degree of mismatching in the a-axis lattice constants between the nonmagnetic intermediate layer and the magnetic layer that are made by sputtering, and Δc is the degree of mismatching in the c-axis lattice constants between the two layers. Under the above conditions, the ferromagnetic crystalline grains cause favorable epitaxial growth in the magnetic layer having hexagonal closest packed (hcp) structure that is the same structure as in the intermediate layer. As a result, alignment and crystallinity in the magnetic layer are improved, and excellent performances in the recording medium are achieved. Because of the little mismatching with the crystalline grains in the intermediate layer, crystalline grains in the magnetic layer even with minute grain size can make favorable epitaxial growth at each minute crystallite.

When a magnetic layer is deposited on a nonmagnetic intermediate layer that predominantly aligns in the hcp (100) plane, growth of crystalline grains in the magnetic layer is inhibited at the epitaxial growth in the a-axis direction that has poorer lattice matching than the c-axis direction with better lattice matching. Consequently the size of the cobalt alloy particles can be made smaller. As a result of the hindrance of the crystal growth in the horizontal direction (i.e., the a-axis direction), segregation of oxide is found promoted in the grain boundary region of the hcp (100)-aligned crystalline grains in the magnetic layer.

In view of this, a magnetic recording medium according to the present invention comprises a substrate and layers including a nonmagnetic underlayer, a magnetic layer, a protective layer, and a lubricant film sequentially laminated on a substrate. The underlayer has a body centered cubic (bcc) structure. The magnetic layer has a granular structure consisting of ferromagnetic crystal grains with hexagonal closest packed (hcp) structure and nonmagnetic grain boundary region of oxide or other nonmagnetic and nonmetallic substance intervening between the ferromagnetic crystal grains.

A magnetic recording medium of the invention further comprises a nonmagnetic intermediate layer with hexagonal closest packed structure disposed between the magnetic layer and the underlayer. The intermediate layer is composed of a nonmagnetic metallic substance mainly composed of one or more element selected from a group consisting of Ru, Os, and Re. A predominant crystal alignment plane parallel to a deposition surface of the substrate is an hcp (100) plane.

The ferromagnetic crystalline grains in the magnetic layer are preferably composed of a CoPt alloy containing at least one element selected from Cr, Ni, and Ta. A degree of lattice mismatching Δa is at most 6% and a degree of lattice mismatching Δc is at most 4%. The ratio Δa/Δc is at least 1.5. Here, Δa is a degree of mismatching between a-axis lattice constant of the ferromagnetic crystalline grain and a-axis lattice constant of the nonmagnetic metallic substance composing the intermediate layer, and Δc is a degree of mismatching between c-axis lattice constants of the two layers.

The substrate is preferably made of plastic resin, such as polycarbonate or polyolefin.

The substrate is preferably not subjected to intentional heating prior to laminating the layers.

### BRIEF DESCRIPTION OF THE DRAWINGS

The invention will be described with reference to certain preferred embodiments thereof and the accompanying drawings, wherein:

FIG. 1 is a drawing illustrating an example of a structure of a magnetic recording medium according to the present invention; and

FIG. 2 is a TEM picture showing a sectional structure of a magnetic recording medium of Example 1.

### DETAILED DESCRIPTION OF THE PREFERRED EMBODIMENTS

### EXAMPLE 1

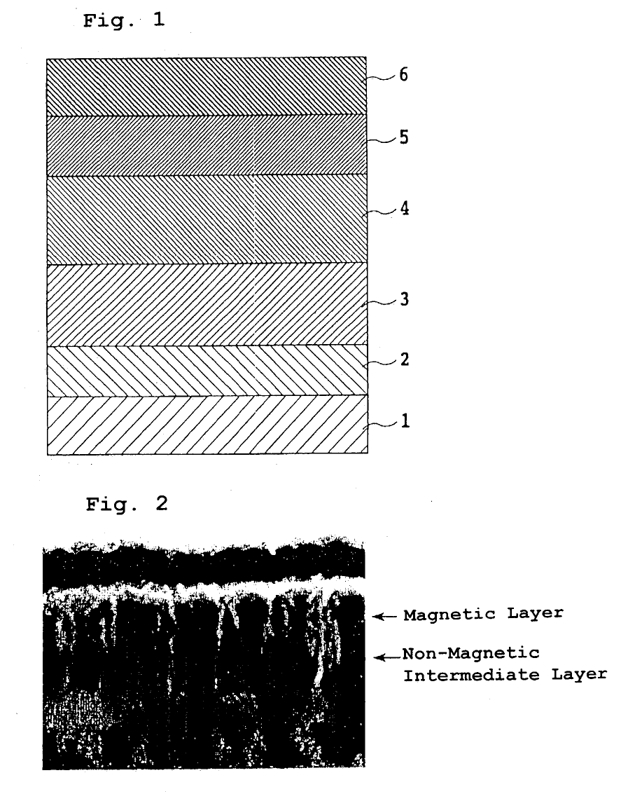

FIG. 1 is a drawing illustrating an example of construction of a structure of a magnetic recording medium according to the present invention. The magnetic recording medium has a layered structure comprising a substrate 1 and the layers laminated on the substrate, the layers including an underlayer 2, a nonmagnetic intermediate layer 3, a magnetic layer 4, a protective layer 5, and a liquid lubricant layer 6. The underlayer 2 is a film made by means of DC sputtering. The nonmagnetic intermediate layer 3 was deposited on the underlayer by means of DC sputtering. The magnetic layer 4 of a cobalt alloy was epitaxially grown on the nonmagnetic intermediate layer 3.

The substrate used was a resin substrate 1 with 3.5″ diameter made of a plastic resin such as polycarbonate or polyolefin. The substrate was cleaned and introduced into a sputtering apparatus. An underlayer 2 of Cr₈₀Mo₂₀ with a body centered cubic (bcc) structure was deposited by a DC sputtering method. A nonmagnetic intermediate layer 3 with the thickness of 30 nm having the hcp structure was formed on the underlayer by means of a DC sputtering method using a ruthenium target at a deposition rate of 2.3 nm/sec under a discharging argon gas pressure of 30 mTorr.

A magnetic layer 4 with the thickness of 10 nm was subsequently formed by means of an RF sputtering method using a target of CO₇₆Cr₁₂Pt₁₂ containing 10 mol % of SiO₂ under a discharging argon gas pressure of 5 mTorr. The magnetic layer 4 has a granular structure consisting of ferromagnetic crystalline grains with the hexagonal closest packed (hcp) structure and nonmagnetic grain boundary region mainly composed of oxide intervening between the ferromagnetic crystalline grains. After laminating a carbon protective layer 5 with the thickness of 8 nm, the laminated substrate was taken out from the vacuum chamber. Finally, a liquid lubricant was applied to the 1.5 nm thickness to form a liquid lubricant layer 6. Thus, a magnetic recording medium was produced. Prior to these laminating processes, no intentional heating of the substrate was conducted.

Table 1 shows the result of an in-plane X-ray diffraction analysis on the crystal structure of the thus fabricated intermediate layer and the magnetic layer.

TABLE 1

| | | mismatching | |
|---|---|---|---|
| index of lattice | intensity ratio to | between Co and | half width |
| plane | I(002) (%) | Ru (%) | (deg) |
| Co (002) | 100 | 3.0 | 0.80 |
| Co (101) | 9 | 5.5 | 1.09 |
| Co (110) | 15 | 6.0 | 1.21 |

As can be seen from the Table 1, weak peaks of Co (101) at about 2θ=30° and Co (110) at about 2θ=46° are observed in addition to the intense peak of Co (002) at about 2θ=28°. The spacing of lattice planes of cobalt composing the magnetic layer has been increased by about 3%. The mismatching Δa between a-axis lattice constants of the nonmagnetic intermediate layer Ru and the magnetic layer Co was 6.0%, and the mismatching Δc between c-axis lattice constants of the two layers was 3.0%. These values of mismatching were lower than the theoretical values. The ratio Δa/Δc was 2.0. The Co (100) plane was found to be the in-plane dominant alignment plane of the magnetic layer.

FIG. 2 is a picture of a cross sectional structure of the nonmagnetic intermediate layer and the magnetic layer taken by an electron transmission microscope (TEM). The TEM image confirms that the magnetic layer was epitaxially grown from the intermediate layer.

Planar TEM observation was conducted to measure the grain size composing these layers. The grain size distribution was a normal distribution in both the intermediate layer and the magnetic layer. The average grain sizes were 6 nm and 4 nm for the intermediate layer and the magnetic layer, respectively. The standard deviation was 1.3 nm for both grain sizes of the two layers. The width of the grain boundary was 1.3 nm.

By virtue of reduction of the degree of mismatching between the lattice constants of the intermediate layer and the magnetic layer in the magnetic recording layer according to the invention, crystallinity and crystal alignment of the magnetic layer were improved, and the crystalline grains composing the magnetic layer were enough minimized and the boundaries of the grains were clear.

A CoPt with the composition of CO₇₆Cr₁₂Pt₁₂ was used for the ferromagnetic crystalline grains in the magnetic layer 4 in this Example 1. However, other CoPt alloy with different composition containing at least an additive element selected from Cr, Ni, and Ta can also be used.

Although the nonmagnetic intermediate layer 3 was deposited using a ruthenium target, other metallic substances composed substantially of at least an element selected from Ru, Os, and Re can also be used.

### COMPARATIVE EXAMPLE 1

A magnetic recording medium was produced under the same conditions as in Example 1 except that the magnetic layer of a cobalt alloy was deposited using a target of CO₈₀Cr₁₂Pt₈ added with 8 mol % of SiO₂ in Comparative Example 1.

Table 2 shows the result of in-plane X-ray diffraction analysis on the crystal structures in the nonmagnetic intermediate layer and the magnetic layer of the thus produced magnetic recording medium.

TABLE 2

| | | mismatching | |
|---|---|---|---|
| index of lattice | intensity ratio to | between Co and | half width |
| plane | I(002) (%) | Ru (%) | (deg) |
| Co (100) | 17 | 6.8 | 0.51 |
| Co (002) | 100 | 4.6 | 1.58 |
| Co (101) | 65 | 7.0 | 1.10 |
| Co (110) | 10 | 7.2 | 1.06 |

As the result shows, the weak peaks of Co (100), Co (101), and Co (110) were observed at around 2θ=26°, 30°, and 46°, respectively, in addition to an intense peak of Co (002) appearing at around 2θ=28°. The spacing of lattice planes of the cobalt composing the magnetic layer increased a little. The mismatching between the a-axis lattice constants of the ruthenium of the intermediate layer and the cobalt of the magnetic layer was 6.8%, and the c-axis lattice constants of the two substances was 4.6%. The values of the mismatching were nearly equals the theoretical values of the mismatching. It was indicated that Co (100) plane was predominantly aligned in the plane of the magnetic layer.

Planar TEM observation on the magnetic layer showed that the width of the grain boundary region was narrow and some regions existed where the boundary of grains was unclear. Planar TEM observation was conducted to measure the grain size in these layers. The grain size distribution showed a distribution having the peaks around the grain sizes of 4 nm and 9 nm. The average grain size was 4 nm, and the standard deviation was 1.8 nm. The width of the grain boundary was 1.0 nm.

The above results have indicated that when the lattice mismatching between the nonmagnetic intermediate layer and the magnetic layer is approximately equal to the theoretical value, the alignment and crystallinity are inhibited and the formation of favorable granular structure is adversely affected.

### COMPARATIVE EXAMPLE 2

Crystallinity was evaluated for a magnetic recording medium produced by using tantalum with a body centered cubic (bcc) structure for a nonmagnetic intermediate layer in Comparative Example 2. The magnetic recording medium of Comparative Example 2 was produced under the same conditions as in Example 1 except that the intermediate layer was composed of tantalum.

Table 3 shows the result of in-plane X-ray diffraction analysis on the crystal structures in the intermediate layer and the magnetic layer of the thus produced magnetic recording medium.

TABLE 3

| | | mismatching | |
|---|---|---|---|
| index of lattice | intensity ratio to | between Co and | half width |
| plane | I(002) (%) | Ru (%) | (deg) |
| Co (100) | 45 | 8.4 | 0.98 |
| Co (002) | 100 | 12.1 | 2.02 |
| Co (101) | 120 | 7.0 | 1.72 |
| Co (110) | 12 | 7.2 | 1.56 |

As the result shows, the weak peaks of Co (100) and Co (110) were observed at around 2θ=26° and 46°, respectively, in addition to intense peaks of Co (002) and Co (101) appearing at around 2θ=30° and 28°, respectively. The spacing of lattice planes of the cobalt composing the magnetic layer increased a little. The mismatching between the a-axis lattice constants of the ruthenium of the intermediate layer and the cobalt of the magnetic layer was 8%, and the mismatching between the c-axis lattice constants of the two substances was 12%, which is a remarkably large value. The alignment of the magnetic layer was demonstrated to be nearly random.

Planar TEM observation on the magnetic layer showed that the width of the grain boundary region was narrow and some regions existed where the boundary of grains was unclear. The grain size measurement indicated the average grain size of 10 nm and the standard deviation of 2.7 nm. The width of the grain boundary was 1.0 nm.

The above results have indicated that when the mismatching of lattice constants is approximately equal to the theoretical value, particularly when the c-axis lattice mismatching between the nonmagnetic intermediated layer and the magnetic layer is remarkably large value of 10% or more, and the material of the nonmagnetic intermediate layer does not have the hcp structure that is the structure of the cobalt of the magnetic layer, the crystalline grains in the magnetic layer randomly orients and the grain size is large.

Electromagnetic conversion characteristics were compared among the magnetic recording media of Example 1, Comparative Example 1, and Comparative Example 2.

Table 4 summarizes the magnetic properties measured by a vibrating sample magnetometer (VSM) and the recording performances of the magnetic disks. The recording performances were measured using a spinning stand tester with read-back output of isolated read-back pulses at a linear recording density of 400 KFCI.

TABLE 4

| Example or | | | | | |
|---|---|---|---|---|---|
| Comp Ex | Hc (Oe) | S | S* | Noise (μV) | SNR (dB) |
| Example 1 | 3,856 | 0.98 | 0.83 | 46.7 | 13.5 |
| Comp Ex 1 | 2,742 | 0.71 | 0.68 | 68.0 | 12.0 |
| Comp Ex 2 | 1,830 | 0.45 | 0.41 | 76.7 | 10.2 |

As indicated in Table 4, the magnetic recording medium of Example 1 resulted in the reduction of noises by more than 30% as compared with Comparative Example 1 and more than 40% as compared with Comparative Example 2. The SNR has been improved by 12% as compared with Comparative Example 1 and by 25% as compared with Comparative Examples 2. The magnetic recording medium of Example 1 performed high coercive force He. Both the squareness ratio S and the coercivity squareness ratio S* in Example 1 are nearer to unity (i.e., nearly square) as compared with Comparative Example 1 and Comparative Example 2. These performances were brought about by improvements of crystallinity and alignment in the magnetic layer of the medium of Example 1, in which decrease in the lattice mismatching made the crystal growth of the magnetic layer epitaxial. Further, the mismatching between a-axis lattice constants of the magnetic layer and the nonmagnetic intermediate layer was made not larger than 6% and the mismatching of c-axis lattice constants not larger than 4%. As a result, the grain size of the crystalline grains composing the magnetic layer was decreased and the interaction between the magnetic crystalline grains was suppressed by promotion of segregation to the grain boundary region, leading to the reduction of noises and the improvement of SNR.

If the lattice matching between the magnetic layer and the nonmagnetic intermediate layer is further favorably controlled, then better electromagnetic conversion characteristics can be achieved.

As described so far, by optimizing the lattice matching between the nonmagnetic intermediate layer and the magnetic layer according to the present invention, improvement of crystallinity and alignment in the magnetic layer, control of the grain size, and promotion of grain boundary segregation can be accomplished. Thus, a magnetic recording layer with low noise and excellent magnetic and electromagnetic conversion characteristics has been provided.

Because the grain boundary segregation of oxides can be promoted by controlling the structure of the nonmagnetic intermediate layer, interactions between the magnetic crystalline grains can be reduced. Consequently, a magnetic recording medium according to the present invention even with minute magnetic particles can hold sufficiently high coercive force at the room temperature. Therefore, stable high density recording can be achieved with little effect of thermal disturbances.

What is claimed is:

1. A magnetic recording medium comprising a substrate and layers sequentially laminated on the substrate, the layers including
a nonmagnetic underlayer having a body centered cubic (bcc) lattice structure,
a magnetic layer having a granular structure consisting of ferromagnetic crystalline grains with a hexagonal closest packed (hcp) structure and nonmagnetic grain boundary region of mainly oxide intervening between the ferromagnetic crystalline grains,
a protective layer, and
a liquid lubricant layer.

2. A magnetic recording medium according to claim 1, further comprising a nonmagnetic intermediate layer with hcp structure, wherein the intermediate layer is composed of nonmagnetic metallic substance consisting essentially of at least one element selected from Ru, Os, and Re, and a predominant crystal alignment plane parallel to a deposition surface of the nonmagnetic substrate is an hcp (100) plane.

3. A magnetic recording medium according to claim 1, wherein the ferromagnetic crystal grains are composed of a CoPt alloy containing at least one element selected from Cr, Ni, and Ta, and a degree of mismatching Δa is at most 6%, a degree of mismatching Δc is at most 4%, and a ratio Δa/Δc is at least 1.5, where Δa is a degree of mismatching between an a-axis lattice constant of the ferromagnetic crystalline grain and an a-axis lattice constant of the nonmagnetic metallic substance composing the intermediate layer, and Ac is a degree of mismatching between a c-axis lattice constant of the ferromagnetic crystalline grain and a c-axis lattice constant of the nonmagnetic metallic substance composing the intermediate layer.

4. A magnetic recording medium according to claim 2, wherein the ferromagnetic crystal grains are composed of a CoPt alloy containing at least one element selected from Cr, Ni, and Ta, and a degree of mismatching Δa is at most 6%, a degree of mismatching Δc is at most 4%, and a ratio Δa/Δc is at least 1.5, where Δa is a degree of mismatching between an a-axis lattice constant of the ferromagnetic crystalline grain and an a-axis lattice constant of the nonmagnetic metallic substance composing the intermediate layer, and Δc is a degree of mismatching between a c-axis lattice constant of the ferromagnetic crystalline grain and a c-axis lattice constant of the nonmagnetic metallic substance composing the intermediate layer.

5. A magnetic recording medium according to claim 1, wherein the substrate is composed of a plastic resin.

6. A magnetic recording medium according to claim 2, wherein the substrate is composed of a plastic resin.

7. A magnetic recording medium according to claim 3, wherein the substrate is composed of a plastic resin.

8. A magnetic recording medium according to claim 4, wherein the substrate is composed of a plastic resin.

9. A magnetic recording medium according to claim 1, wherein the substrate is not subjected to intentional heating prior to laminating the layers.

10. A magnetic recording medium according to claim 2, wherein the substrate is not subjected to intentional heating prior to laminating the layers.

11. A magnetic recording medium according to claim 3, wherein the substrate is not subjected to intentional heating prior to laminating the layers.

12. A magnetic recording medium according to claim 4, wherein the substrate is not subjected to intentional heating prior to laminating the layers.

13. A magnetic recording medium according to claim 5, wherein the substrate is not subjected to intentional heating prior to laminating the layers.

14. A magnetic recording medium according to claim 6, wherein the substrate is not subjected to intentional heating prior to laminating the layers.

15. A magnetic recording medium according to claim 7, wherein the substrate is not subjected to intentional heating prior to laminating the layers.

16. A magnetic recording medium according to claim 8, wherein the substrate is not subjected to intentional heating prior to laminating the layers.
